(19) United States
(12) Patent Application Publication
(10) Pub. No.: US 2002/0079313 A1
(43) Pub. Date: Jun. 27, 2002

(54) Modular storage system

(76) Inventor: Jeremy M. Grayson, (US)

Correspondence Address: Tim F. Williams, DORITY & MANNING, P.A., P.O. Box 1449, Greenville, SC, 29602-1449, US

(21) Appl. No.: 09/750,453

(22) Filed: Dec. 27, 2000

(51) Int. Cl. B65D 21/02; A47G 19/00; A01K 97/06

(52) U.S. Cl. 220/23.4; 43/57.1

(57) ABSTRACT

The present invention provides a modular storage system. Interconnectable or modular components are provided that may be selectively combined with other such components to provide a system for the storage, transport, and organization of various items.

### FIELD OF THE INVENTION

The present invention relates to an expandable, modular storage system. More specifically, the present invention provides an interconnectable or modular component that may be selectively combined with other such components to provide a system for the storage, transport, and organization of various items. While the present invention will be discussed in terms of providing a storage system for fishing tackle and related equipment, the invention is not limited solely for use with such items and, instead, may be used with any variety of items as desired by the user.

### BACKGROUND OF THE INVENTION

Perhaps beginning with the use of hooks and lures to catch fish, anglers have been confronted with the problems of storing, transporting, and organizing fishing tackle and related equipment. Lines can become entangled in other lures, clothing, and occasionally the unwary angler. Spare fishing line loose in a tackle box can wrap its way around tackle and other equipment. Other small items, such as weights, swivels, and beads inevitably find a way to scatter.

Tackle boxes have been developed in which anglers may store lures and other fishing equipment. The angler seeking to purchase a tackle box is typically confronted with an array of products having various features. Unfortunately, features such as the overall size and internal configuration of commercially available tackle boxes may be predetermined by the manufacturer during the design process in an effort to make the most profitable choices among competing design goals. In addition, customization is typically limited or nonexistent with such products.

By way of example, conventional tackle boxes may have internal trays that fold out in accordion-like fashion. Internal compartments within the trays may be adjustable but the number of trays is typically predetermined. The trays are usually not equipped with lids, or the lids provide cover for the entire tray rather than individual compartments. While such tackle boxes may provide storage for numerous lures, they are typically bulky and cumbersome. In the event the tackle box is tipped over or picked up before locking the cover, the contents or some portion thereof may be spilled because the lids tend to provide cover for multiple compartments.

Tackle boxes are also available that may include stacked, unconnected trays that fit into a flexible carrying bag or pouch. Typically, the containers may have one lid covering individual compartments within the container. While the individual containers may be opened separately, the contents of each compartment within the individual container are subject to spillage in the event the container is tipped or dropped while open. Such containers are also generally too cumbersome for the angler to carry with a sling or belt while fishing. Again, the overall size of the container and total number of possible compartments is usually predetermined by the manufacturer.

### SUMMARY OF THE INVENTION

In response to some of the difficulties and drawbacks discussed above, a new modular storage system has been discovered. While the storage system and its components will be discussed in terms of use with fishing tackle or other sporting goods, the scope of the present invention is not limited to use with such items. Instead, the present invention may be used to store, transport, and organize any items or things as desired by the user.

As one of many exemplary uses, the present invention provides a modular storage system with interconnectable components that may be selectively connected by an angler to form a tackle box having any number of desired compartments as determined by the angler. Each component may be configured with a lid so that in the event the tackle box is tipped or dropped, only the contents of those components open will be spilled rather than the entire tackle box or a large portion thereof. Individual components can be further subdivided by the angler to provide an additional degree of organization. The present invention encompasses both the individual modular components that may be used to form a modular storage system as well as the entire interconnected system of components forming such a modular storage system.

In an exemplary embodiment of the present invention, a modular component of an expandable tackle box system is provided. The modular component is formed from a receptacle having plurality of sides and a bottom. While the receptacle may be square or rectangular, other shapes are permitted and may be desirable. The sides or walls of the receptacle are configured so as to form an interior for the receipt of fishing lures or other items. Various sizes of receptacles are within the scope of the present invention. By way of example only, the receptacle may be sized for the receipt of only one lure or may be much larger so as to allow for the storage of weights, corks, a fish hook remover, or even multiple lures. Such a receptacle may also be sized by varying not only the length or width but also the depth of the receptacle.

One advantage of selecting a receptacle size large enough for a single lure is that the hooks are protected from entanglement with other lures. Rather than having several lures in the same compartment, this exemplary embodiment of the present invention enables the angler to keep each lure in a single receptacle or compartment. In addition, a lure manufacturer can market and sell lures already placed within a receptacle. Purchasing such a product, the angler can simply add a new modular component to the modular tackle box system. Thus, this embodiment of the present invention ensures that the angler has enough tackle box space to hold the new lure, allows the angler to expand the tackle box system only as needed, and provides a package for marketing the lure.

In addition, the interior of the modular component may be further compartmentalized. By way of example, the receptacle may be further subdivided using partitions. Such partitions may be permanent, or the interior of the receptacle may be structured to allow the angler to place the partitions as desired. For example, the partitions may consist of removeable walls that may be snapped, inserted, or otherwise removeably positioned as decided by the angler.

The modular component may be constructed from a variety of materials suitable for manufacture and compatibility with the intended use of the tackle box system. For fishing applications, a material that is lightweight but durable may be most desirable. For example, the modular component may be constructed from various plastics, including a clear or translucent plastic, so as to allow the angler to see the contents of the modular component without having to open the component for inspection. However, other materials, including wood, metal, and various composites may be used as a material of construction. In certain applications it may even be desirable to use an opaque plastic so as to protect the contents from exposure to ultraviolet light.

Continuing with the exemplary embodiment of the present invention, a door or lid by be provided for closing the opening or access to the interior of the modular component. Each modular component may have such a separate cover so that the angler or other user is only required to open one modular component at a time and thereby minimize the change of spilling. While the cover for the modular component would typically be constructed from the same material as the receptacle, such is not a requirement of the present invention and different materials may be used. In addition, a given modular component may have more than one cover configured for allowing the angler to access different compartments that may exist within the receptacle or simply to allow access to different areas of the interior of receptacle.

The connection of the cover to the receptacle may be configured so as to allow ready access to the interior of the exemplary modular component. The attachment may be any variety of configurations; examples include a hinged attachment or a sliding door arrangement. The cover may be permanently affixed to the receptacle by such a hinge or may be completely removable. The hinge may be formed as an integral part of the cover and receptacle or may be of separate construction. Using the teachings disclosed herein, one of ordinary skill in the art may envision other constructions for allowing the cover to by selectively placed over the opening to the interior of the receptacle and such are within the spirit and scope of the present invention.

For the exemplary embodiment being discussed, numerous configurations may be envisioned for locking or affixing the cover in place when the modular component is to be closed. By way of example, the receptacle may be configured with a pin which locks into a receiving latch located on the cover or lid. This arrangement could also be reversed. Alternatively, the lid or receptacle may be fitted with lip or ridge that snaps into place in a groove located in complementary fashion on the lid or receptacle. In still another example, the lid or receptacle may be fitted with a series of pins and complementary receiving holes for selectively holding the lid in place. Various sliding locks and engagement mechanisms may be envisioned by one of ordinary skill in the art using the teachings disclosed herein.

Depending upon the configuration used, the modular component may be watertight but such is not a requirement of the present invention. A watertight or waterproof modular component may be desirable so that the modular component will float in the event it is dropped into water, such as a lake or stream. Using the teachings disclosed herein, one of ordinary skill in the art may envision various features or devices for attaining a waterproof seal for the modular component. By way of examples only, such features may include o-rings, interlocking tabs, interlocking ridges or lips, and the like.

Continuing with the exemplary embodiment, the individual modular components are configured so that such modular components may be interconnected to form a modular tackle box system. For example, the modular components may be configured for interconnection by providing complementary connectors on at least two sides of the plurality of sides of each modular component. If the modular component is constructed from a square or rectangular shape, complementary connectors may be disposed on the exterior of two generally parallel or planar sides of the modular component. In this way, the modular components may be interconnected in adjacent fashion as desired by the angler. Depending upon the angler's needs or situation, two, five, or larger numbers of such modular components may be interconnected to provide and expand the modular tackle box system.

In addition, the modular components may also be equipped with connectors located on the bottom of each modular component. By configuring such connectors in complementary fashion on each modular component, the angler can also interconnect the bottoms of the modular components and/or interconnect the modular components in adjacent fashion. This feature would allow the angler to expand in two dimensions the number of modular components forming the modular tackle box.

Alternatively, a third surface may be configured for complementary connection with the modular component or with a series of adjacently interconnected modular components configured with connectors on the bottom. By way of example, such third surface may be located within or upon a conventional tackle box. The angler could then place modular components within such a tackle box and remove them later when needed. Rather than having several tackle boxes, the angler could have numerous interconnectable modular components for placement into one tackle box. Before departing on a fishing trip, the angler could simply select those modular components containing those fishing lures or other equipment the angler expects to use under the circumstances. In the event the tackle box is tipped over or dropped, only those modular components that are open would be subject to spillage. By limiting the number of such modular components open at any given time, the angler could minimize the time spent recovering spilled contents from the bottom of a boat or worse, the bottom of the water being fished.

As a further example, such a third surface could be configured for attaching a modular component or a series of modular components to the angler's belt or fishing vest. Instead of carrying a bulky tackle box while walking in a slippery trout stream, the angler could simply select a handful of modular components containing the most promising lures and attach them to the angler's belt, vest, or other third surface located upon the angler. This would free the angler's hands for fishing rather than carrying. In addition, the rest of the tackle box could be left safely on shore.

To enable the interconnection of the exemplary modular components to other such modular components, or to enable the connection of such modular components to a third surface, a variety of different types of connectors may be configured in complementary fashion so as to allow the formation of the modular storage or tackle box system from the modular components. By way of examples only, the connectors may be constructed from pins and holes, mushroom heads and holes, tongue and groove, tab and groove, Velcro, sliding tabs and grooves, and/or magnets. The connectors may be integrally formed from the sides or walls of the modular component, or the connectors may consist of separate elements. Using the teachings disclosed herein, various other types of connectors may be envisioned by one of ordinary skill in the art for connecting the modular components as described. Each is within the spirit and scope of the present invention.

These and other features, aspects and advantages of the present invention will become better understood with reference to the following description and appended claims. The accompanying drawings, which are incorporated in and constitute a part of this specification, illustrate an exmeplary embodiment of the invention and, together with the description, serve to explain the principles of the invention. While the present invention will be discussed in terms of the storage of fishing tackle or other sporting equipment, the scope of the present invention is not limited by the identity of the items stored by the user. As will be apparent to one of ordinary skill in the art using the teachings disclosed herein, the present invention may be used to store a variety of items as desired and determined by the user.

### BRIEF DESCRIPTION OF THE DRAWINGS

FIG. 1 is a perspective view of an embodiment of the present invention depicting, by way of example, the storage of fishing lures.

FIG. 2 is a perspective view of an embodiment of the present invention.

FIG. 3 is another perspective view of the embodiment of the present invention depicted in FIG. 2.

FIG. 4 is a cross-sectional side view of the embodiment shown in FIG. 2 and depicts, by way of example, the storage of a fishing lure.

FIGS. 5 and 6 are additional cross-sectional views from opposite ends of the embodiment shown in FIG. 2.

FIGS. 7 and 8 are additional perspective views of the embodiment shown in FIG. 2.

FIG. 9 is a top perspective view of an embodiment of the present invention.

FIG. 10 is an end perspective view of the embodiment depicted in FIG. 9.

FIG. 11 is a perspective view of an embodiment of the present invention.

FIG. 12 is a perspective view of an embodiment of the present invention.

FIG. 13 is a perspective view of an embodiment of the present invention.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are apparent from the following detailed description. It is to be understood by one of ordinary skill in the art that the present discussion is a description of exemplary embodiments only and is not intended as limiting the broader aspects of the present invention.

In general, the present invention relates to a modular storage system. More specifically, the present invention provides an interconnectable or modular component that may be combined, as desired by the user, with other such modular components so as to provide an expandable system for the storage, transport, and organization of a variety of items. In certain embodiments, the modular component may be configured with a third surface to provide for the attachment of the modular component, or an interconnected series of such modular components, to the third surface.

The scope of the present invention includes the individual modular components as well as the modular storage system provided by the interconnection of such modular components. While the present invention will be discussed and explained with example embodiments showing the storage of fishing gear and related equipment, the modular storage system disclosed herein may be used for the storage, transport, and/or organization of any items as desired by the user and such is within the spirit and scope of the present invention. Thus, the present invention is not limited solely to use with fishing or sporting equipment and may be used with any variety of items as determined by the user.

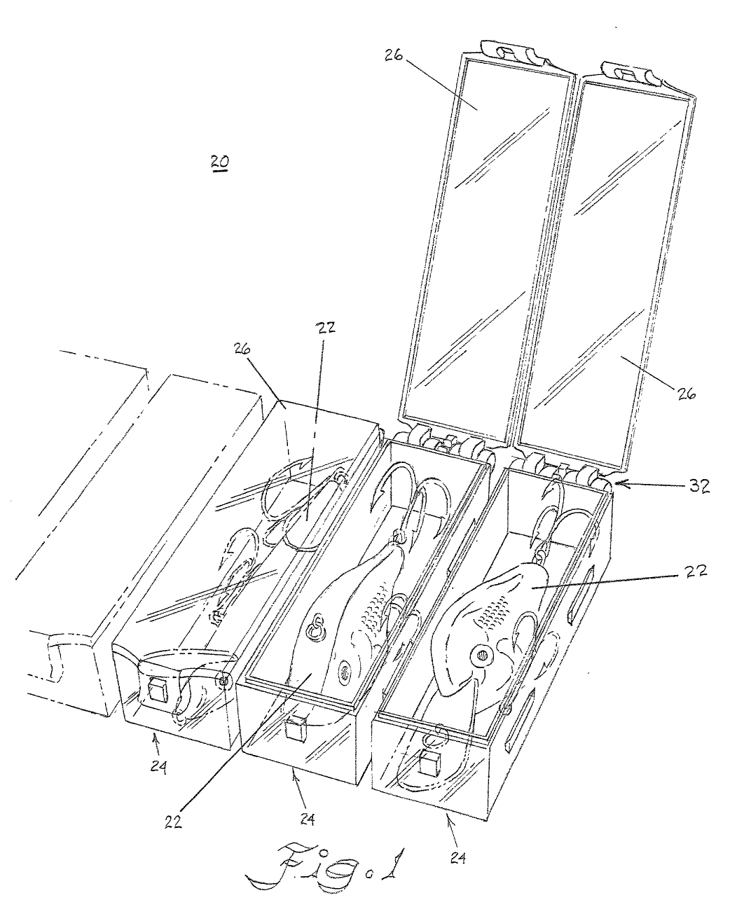

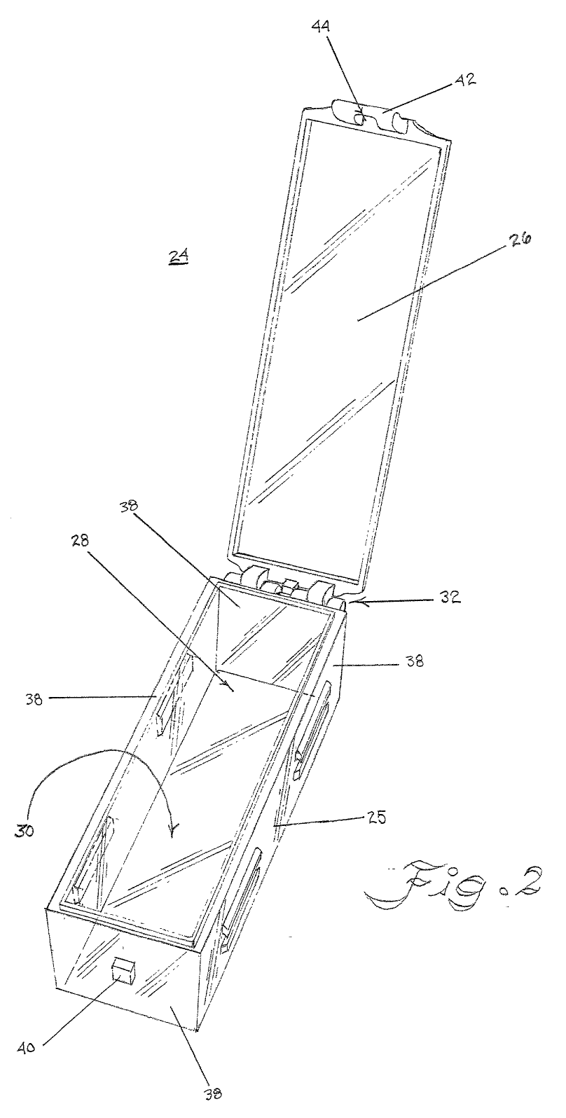

Reference is now made to FIG. 1 wherein an exemplary embodiment of a modular storage system 20 is depicted in use with various fishing lures 22. The modular storage system 20 includes a plurality of interconnected modular components 24. An exemplary embodiment of a single interconnectable modular component 24 is shown in FIG. 2. The interconnected components 24 each provide storage for a fishing lure 22 or other items. Using features that will be described herein, each modular component 24 may be connected to other such components 24 as desired by the angler or user to form the modular storage system 20.

With this exemplary embodiment of the present invention, numerous advantages are provided to the angler. By way of example only, the angler can interconnect the modular components 24 so as to only carry those lures 22 or equipment necessary for the fishing trip at hand. The angler might store numerous components 24 at home and then select and interconnect only those components 24 containing gear needed for each excursion. Different lures 22 might be selected depending upon whether the angler is in search of bass, crappie, striper, walleye, pike, or other fish. In general, different fish and varying habitats require the angler to vary the lures, rigging, and other equipment to maximize the chances of a catch. Rather than having to transport the entire tackle box or perhaps even multiple boxes, this embodiment of the present invention allows the angler to leave unnecessary gear behind.

While the modular components 24 depicted in FIG. 1 and FIG. 2 contain a single lure, such is presented by way of example only. The size, shape, and dimensions of each component 24 can be varied to provide numerous options for the storage, transport, and organization of fishing gear and other items. For example, the modular components 24 may be much larger than is depicted in FIG. 1 so that items such as pliers, fish hook removers, flashlights, or other larger gear may be stored. Alternatively, smaller components 24 may be provided to store hooks, weights, beads, and other generally smaller items. By way of further example, the shape of the component 24 need not be rectangular and, instead, may be varied depending upon the particular applications intended for the modular storage system 20.

The modular components 24 may be constructed from a variety of materials. For the exemplary embodiment depicted in FIG. 1, a translucent or clear plastic is depicted. Using such as a material of construction allows the angler to determine the contents of the components 24 without the necessity of opening the same. However, the present invention is not limited to the use of plastic or a translucent material. Instead, any material of construction may be utilized as may be required depending upon the application intended and the requirements of manufacture, including materials that may be opaque. By way of example, materials of construction may include wood, metal, composites, or other suitable materials.

As shown in FIG. 2, this exemplary embodiment of the modular component 24 includes a receptacle 25 and a door 26. While the modular component 24 is in use, either in singular or interconnected with other such components 24, the door 26 allows for selectively opening and closing the access or opening 28 to the interior 30 of the receptacle 25. Also referred to as a top cover, or lid, the door 26 allows the angler to only access the particular receptacles 25 needed at any particular moment. This feature works to minimize the spilling and loss of gear whenever the modular component 24 or tackle box is tipped over. For example, anglers may frequently changes lures 22 or rigging during the course of a fishing trip in an effort to find the fish or to find the particular type or color of lure 22 that is attractive to the fish under then existing conditions. With some conventional tackle boxes, the angler would have to open the entire tackle box or usually some large portion thereof. In the confines of a boat on a windy lake, the chances of tipping over such a conventional tackle box or some portion thereof is apparent.

Utilizing the embodiment of the present invention depicted in FIG. I and FIG. 2, the angler can minimize the chances of losing gear or wasting valuable fishing time placing spilled lures and other gear back into storage. By only opening the particular components 24 needed at any given moment, the angler can ensure that little or no contents are lost or spilled in the event the modular storage system 20 is dropped or tipped. Because multiple components 24 can be interconnected as desired (and as will be described herein), the angler is provided with the option of creating a highly organized modular storage system 20 wherein gear may be stored separately in multiple closed components 24. This feature allows the angler to only open individual modular components 24 as desired so as to minimize the chances of loss or spillage.

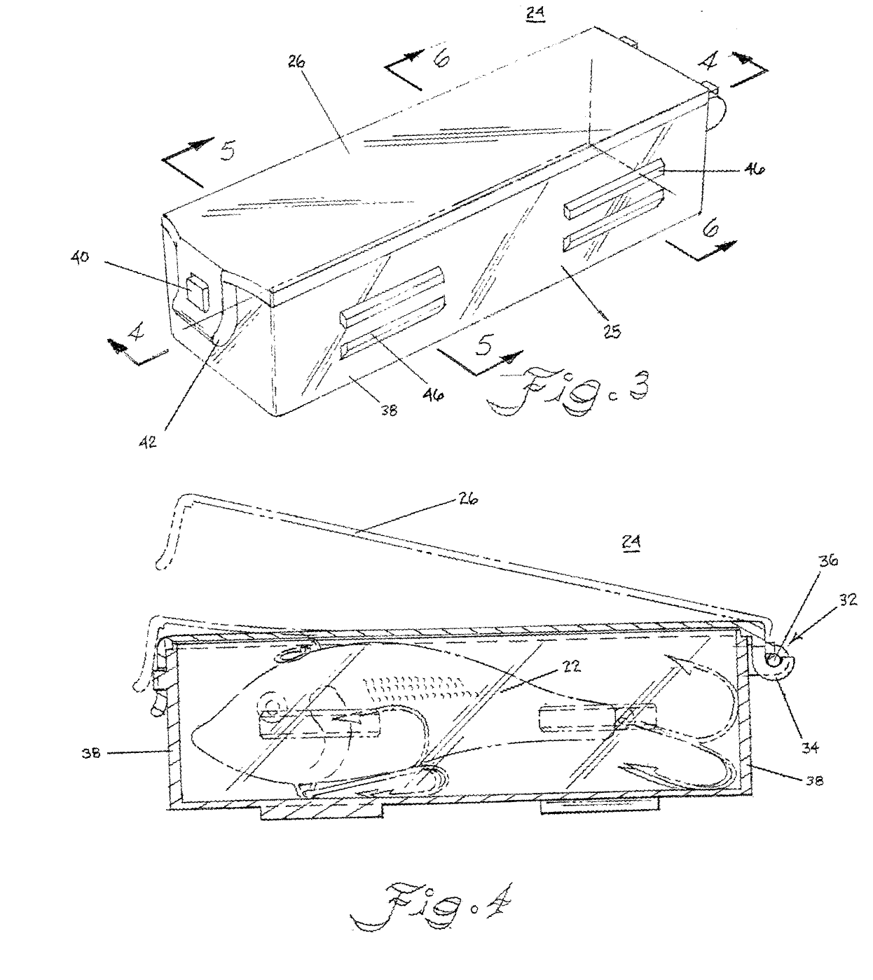

While not required for all embodiments of the present invention, the door 26 may be configured with a hinge 32 as shown in FIG. 1 and FIG. 2. The hinge 32 allows the door 26 to be positioned as the angler desires so as to selectively cover and uncover, or open and close, the opening 28 to the interior 30 of the receptacle 25. FIG. 4 shows the operation of the hinge 32 for this particular embodiment. As shown in FIG. 4 and in FIG. 7, hinge 32 may be constructed from a pair of j-hooks 34 that grip and rotate about a shaft 36. The use of this type of hinge 32 allows for the removal of the door 26 from the receptacle 25 by separation of the j-hooks 34 from the shaft 36. This feature may be desirable to some anglers and also aids in the manufacturing process by allowing the receptacle 25 and door 26 to be manufactured separately.

For the embodiment shown in FIG. 2, FIG. 4 and FIG. 7, the hinge 32 is integrally formed as a part of or from the door 26 and receptacle 25. More specifically, the j-hooks 34 are an integral part of the door 26 while the shaft 36 is an integral part of the receptacle 25. However, this depiction of the hinge 32 is provided only by way of example; other configurations for the hinge 32 may be used and will be apparent to those of ordinary skill in the art using the teachings disclosed herein. For example, the hinge 32 may be configured as a conventional piano-style hinge wherein cylinders rotate about a pin or shaft. As another example, the hinge 32 may simply include a flexible strap or straps connected to the door 26 and receptacle 25.

In addition, the hinge 32 need not be located at the exact position on the receptacle 25 as shown. Referring specifically to FIG. 2, for the embodiment shown receptacle 25 includes a plurality of sides or walls 38. The hinge 32, or any other mechanism for connecting the door 26 with receptacle 25, may be located on any of the walls 38. Accordingly, the hinge 32 could be constructed from a thin, flexible bridge of material connecting any of the walls 38 with a corresponding side of the door 26. Furthermore, the attachment or configuration of the door 26 with receptacle 25 is not limited to the use of a hinge 32. A variety of other configurations may be envisioned, using the teachings disclosed herein, for providing the receptacle 25 with a door 26. By way of example only, the receptacle 25 may include grooves for receipt of a door 26 that may be slid into an open or closed position within such grooves. These and other examples are within the spirit and scope of the present invention.

The door 26 may be constructed from the same material as receptacle 25, although this is not required. As discussed, some anglers or users may prefer that the door 26 be constructed of a clear, transparent, or translucent material. Such feature would allow the angler or user to view the contents within the interior 30 of the receptacle 25 without removal or opening of the door 26. The door 26 and receptacle 25 may also be configured such that component 24 is waterproof or water resistant. For example, o-rings, snap-fits, seals, and various other features or mechanisms may be used to create a water resistant or waterproof component.

The modular component 24 may include a mechanism for locking or fastening the door 26 to the receptacle 25 when the angler intends for the opening 28 to the interior 30 to remain closed, as is shown in the exemplary embodiment depicted in FIG. 3. Such a mechanism may include a locking pin 40 and a receiving latch 42. Accordingly, as the door 26 is pressed or moved from the open position shown in FIG. 2 to the closed position shown in FIG. 3, the locking pin 40 snaps or fits into an opening 44 in the receiving latch 42. By lifting latch 42, the door 26 may again be lifted from the receptacle 25, allowing the angler to gain access to the interior 30. This pin 30 and latch 42 are but one example of a mechanism for latching or securing the door 26 into place. Other examples, including pins and complementary receiving holes, ridges and grooves, and various other mechanisms may by envisioned by one of ordinary skill in the art using the teachings disclosed herein.

As already indicated, the exemplary embodiment of the present invention described herein provides a modular storage system 20 that allows for the interconnection of the modular components 24 so as to form a plurality of interconnected components 24. The components 24 can be attached in number and fashion as desired by the angler or user for a particular application. To allow for the interconnection of the exemplary modular components 24, means are provided for selectively attaching each component 24 in adjacent and complementary fashion to other such components 24 as will now be described using an exemplary embodiment.

Referring now to FIG. 2 through FIG. 8, the receptacle 25 (also referred to as compartment or container), in certain embodiments includes the plurality of walls or sides 38 that form the access or opening 28 to the interior 30. At least two of the sides 38 of the exemplary receptacle 24 may be generally parallel or planar, as depicted in FIG. 2 and FIG. 3. While this is not a requirement of the present invention, such a feature readily allows for the interconnection of multiple components 24 in adjacent fashion. The interior 30 of receptacle 25 may be further subdivided using temporary or permanent partitions, thereby providing the angler with additional options for organization.

Configured upon the sides 38 of receptacles 25 are means for selectively attaching each modular component 24 to other such components 24 configured in complementary fashion. For the exemplary embodiment being discussed, such means are generally located upon at least two of the sides 38 of receptacle 25. As shown in FIG. 3, one of the sides 38 of receptacle 25 includes a pair of female connectors 46. These female connectors 46 are each constructed from two lugs that are configured for the complementary receipt of a pair of male connectors 48. As shown in FIG. 7, such male connectors 48 are located on an opposite side 38 of receptacle 25 from the female connectors 46.

Accordingly, a series of modular components 24 may be constructed in adjacent fashion, as shown in FIG. 1, by positioning a pair of components 24 side by side and then pressing or sliding the components so as to engage the female and male connectors 46 and 48. This pair of components 24 may then be connected with another component 24 in similar fashion. This process can then be repeated as many times as desired by the angler or other user until the desired number of components 24 is obtained to form system 20. FIG. 9 also shows, in part, a top view of three components 24 connected in adjacent fashion as described.

The present invention does not require that pairs of female and male connectors 46 and 48 be used on each side 38 of the receptacle 25 as shown in FIG. 2, FIG. 3, and FIG. 7. Instead, one female connector 46 or one male connector 48 may be used. In addition, such connectors 46 and 48 may be longer, oriented differently, or placed in a different locations upon the sides 38 of receptacle 25. Furthermore, the sides 38 of receptacle 25 are referred to generally, rather than using designations such as right and left, front or back, to indicate that the female connector 46 can be on either side and, similarly, the male connector 48 can be located on either side. For adjacent connection of multiple components 24, the present invention requires that the connectors be configured in complementary fashion. Therefore, using the teachings disclosed herein, one of ordinary skill in the art can envision differing configurations, orientations, and locations for these connectors that are within the spirit and scope of the present invention.

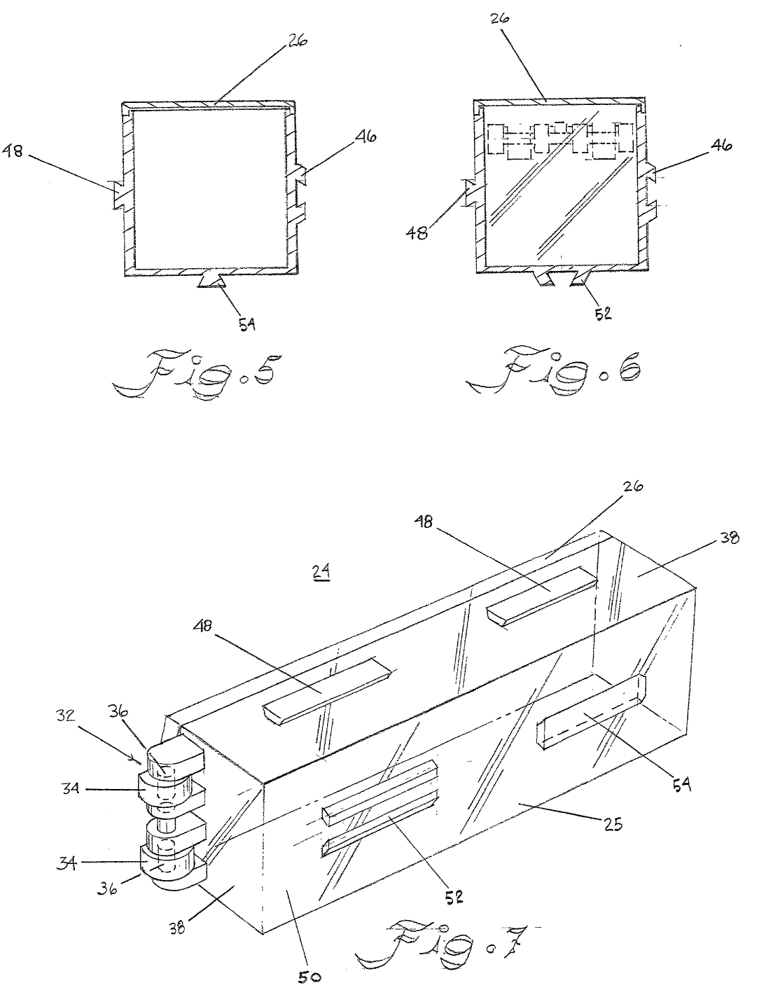

FIG. 5 and FIG. 6 depict an example of construction of the female connector 46 and the male connector 48. The female connector 46 is configured for receipt of a male connector 48 configured in complementary fashion. The connectors 46 and 48 can be pressed together or slid together to connect the modular components 24. As will be understood by on of ordinary skill in the art using the teachings disclosed herein, the configuration of the connectors 46 and 48 is not limited to the structures or shapes shown in cross-section in FIG. 5 and FIG. 6. Connectors 46 and 48 serve by way of example and not limitation. Instead, any type of connectors suitable for attachment of one modular component 24 to another such component 24 may be used. By way of example, only, such connectors may be constructed from pins and holes, mushroom heads and holes, tongue and groove, tab and groove, Velcro, sliding tabs and grooves, magnets, and or other suitable types of fasteners. The connectors may be integrally formed from the sides or walls of the modular component, or the connectors may consist of separate elements. Using the teachings disclosed herein, various other types of connectors may be envisioned by one of ordinary skill in the art for connecting the modular components 24 as described, and each is within the spirit and scope of the present invention.

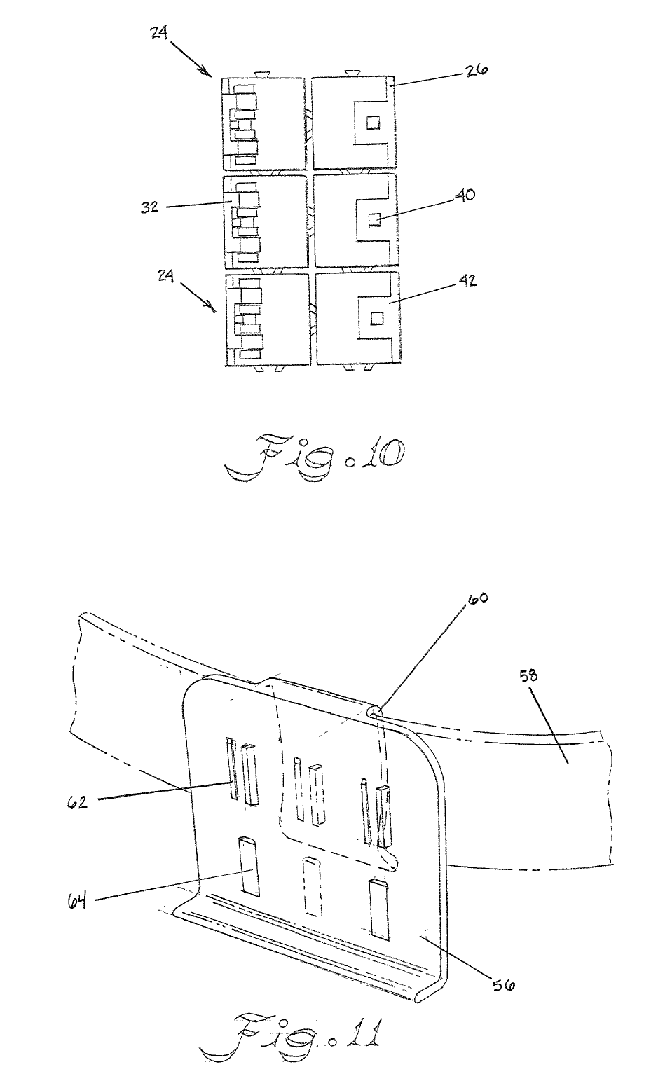

In certain embodiments, the present invention may also provide means for connecting the modular component 24 by connectors located on the bottom 50 of the component 24. This feature allows the components 24 to be attached not only in adjacent fashion as discussed above but also by connecting the bottoms 50 of the components 24 as is depicted in FIG. 9 and FIG. 10. Accordingly, the angler other user is provided with the option of expanding the modular component system 20, component 24 by component 24, in two dimensions.

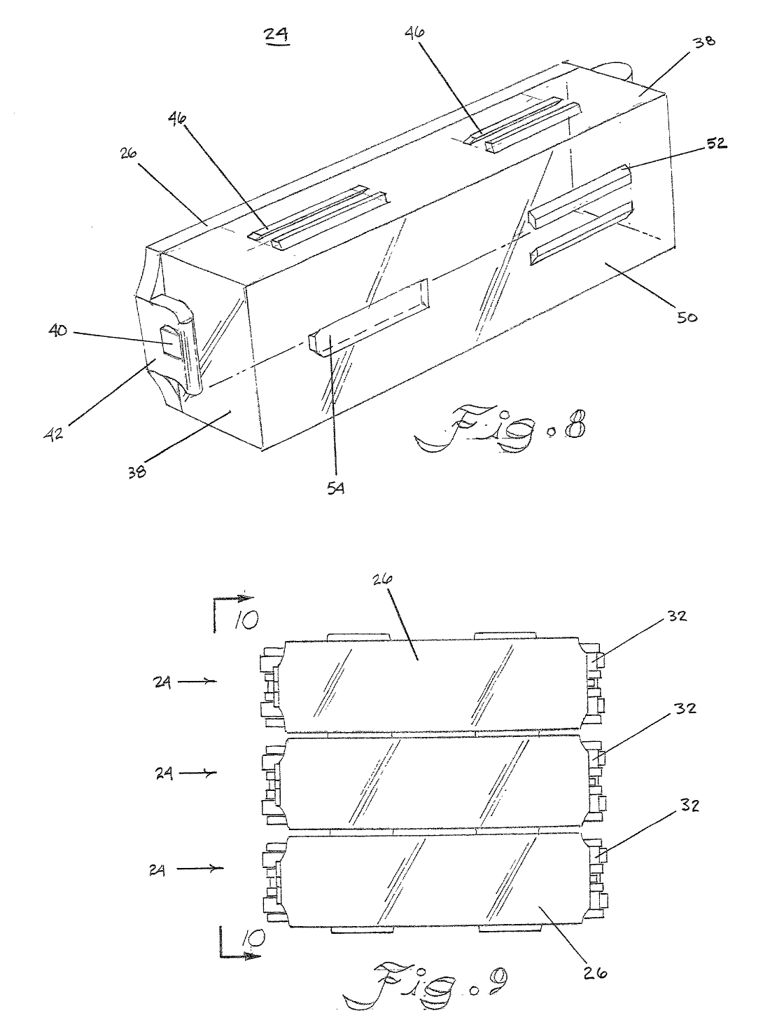

Referring specifically now to FIG. 5 through FIG. 8, configured upon the bottom 50 of receptacle 25 are means for selectively attaching each component 24 to other such components 24 configured in complementary fashion. As shown in FIG. 7 and FIG. 8, the bottom 50 may include both a female connector 52 and a male connector 54. The female connector 52 is constructed for the complementary receipt of the male connector 54 located on the bottom of another receptacle 25. In accordance therewith, the bottom 50 of one modular component 24 may be connected with the bottom 50 of another modular component 24 by positioning the respective bottoms 50 of the components 24 together and then pressing or sliding the components 24 so as to engage the connectors. This process can be repeated multiple times and can also be used for connecting components 24 that are also connected in adjacent fashion as already described above.

The present invention does not require that both a female connector 52 and a male connector 54 be configured on the bottom 50 of each component 24. The embodiment shown in FIG. 7 and FIG. 8 is for illustrative purposes only. For example, the bottoms 50 of the components 24 may be connected by using only one connector or even more than a pair of connectors. In addition, the connectors may be longer, oriented differently, or placed in different locations upon the bottom 50 of component 24. Using the teachings disclosed herein, one of ordinary skill in the art can envision multiple configurations, orientations, and locations of the connectors and each are within the spirit and scope of the present invention.

FIG. 5 and FIG. 6 illustrate an example of the construction of the male connector 54 and female connector 52. The female connector 52 is configured for receipt of a male connector 54 configured in complementary fashion. The connectors 52 and 54 can be pressed together or slid together to connect the bottoms 50 of the modular components 24. The connectors on the modular components 24 can also be configured for embodiments where the side 38 of one component 24 may be connected to the bottom 50 of another component 24.

As will be understood by one of ordinary skill in the art using the teachings disclosed herein, the configuration of the connectors 52 and 54 is not limited to the structures or shapes shown in cross-section in FIG. 5 and FIG. 6. As with connectors 46 and 48, the connectors 52 and 54 depicted serve by way of example and not limitation. Instead, any type of connectors suitable for attachment of one modular component 24 to another such component 24 may be used. By way of example only, such connectors may be constructed from pins and holes, mushroom heads and holes, tongue and groove, tab and groove, Velcro, sliding tabs and grooves, magnets, and or other suitable types of fasteners. The connectors may be integrally formed from the sides or walls of the modular component 24, or the connectors may consist of separate elements. Using the teachings disclosed herein, various other types of connectors may be envisioned by one of ordinary skill in the art for connecting the modular components 24 as described and each is within the spirit and scope of the present invention.

As an additional feature of the present invention, other surfaces and containers may be configured for the complementary receipt of, or attachment with, individual modular components 24 or a plurality of interconnected modular components 24. Such other surfaces and containers may include a vest to be worn by the angler, an attachment to be worn on a belt, a tackle box, internal trays within a tackle box, the external surfaces of a tackle box, and numerous others that will be apparent to one of ordinary skill in the art using the teachings disclosed herein. Accordingly, the user or angler is provided with another advantage of the present invention that allows additional options for the transport, storage, or organization of gear using the modular storage system 20.

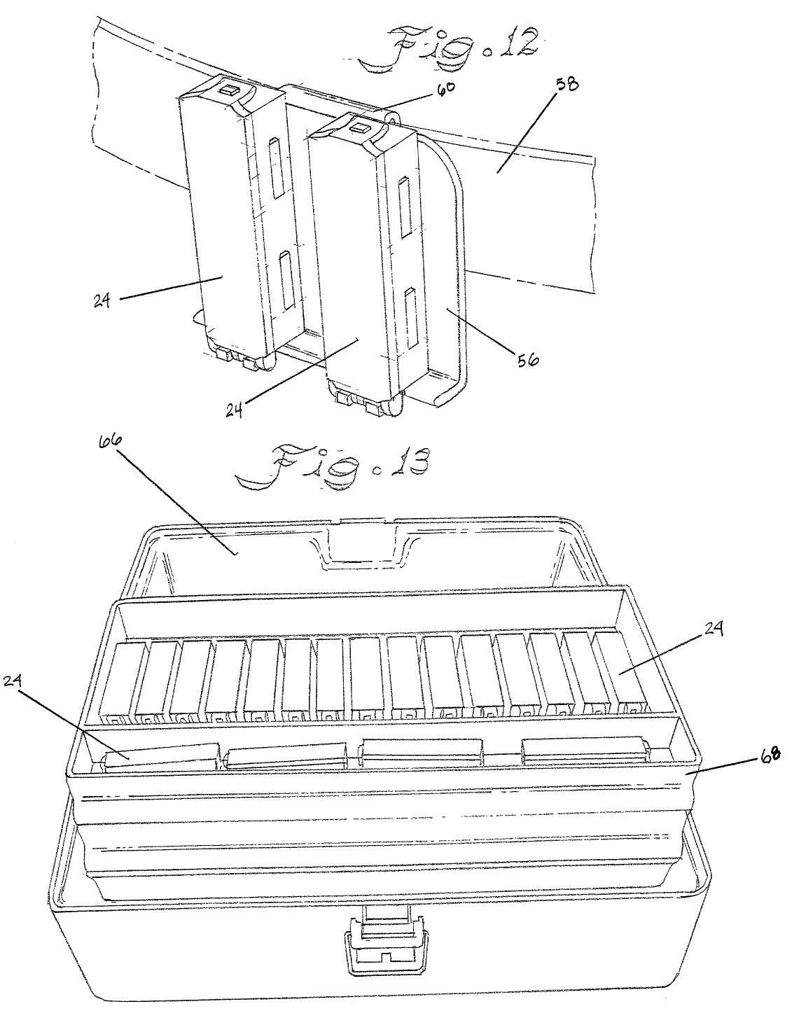

By way of example, FIG. 11 shows an exemplary embodiment of a belt attachment 56 in place upon a belt 58. The belt attachment 56 includes a clip 60 for securing the attachment 56 to belt 58. The belt 58 may be worn about an angler's hip or waist and thereby free the angler's hands and provide read access to lures, gear, or other items. Configured upon the belt attachment 56 are means for connecting modular components 24. For the exemplary embodiment depicted in FIG. 11, such connecting means includes female connectors 62 and male connectors 64 configured for complementary receipt of the female and male connectors 46 and 48, or the female and male connectors 62 and 64 located upon modular component 24. FIG. 12 demonstrates a pair of modular components 24 placed upon attachment 56.

FIG. 11 and FIG. 12 serve to only to illustrate an exemplar embodiment of the present invention. Numerous variations within the spirit and scope of the present invention can be envisioned by one of ordinary skill in the art using the teaching disclosed herein. By way of example only, the number, size, orientation, and type of connectors used on belt attachment 56 can be varied as described above with regard to connectors 46 and 48, and connectors 52 and 54. Furthermore, the number of components 24 attached to the belt can be varied and such components 24 may also be connected in adjacent fashion to each other as well as being connected to belt attachment 56. Belt attachment 56 and clip 60 can be varied in shape, size, and as otherwise needed to allow the angler to carry components 24.

FIG. 13 shows yet another embodiment of the present invention in which a conventional styled tackle box 66 may be configured for the complementary receipt and storage of various modular components 24. The internal trays 68 of the tackle box 66 may be configured for receipt of modular components 24. Alternatively, the interior or exterior surface of tackle box 66 may be configured for receipt of the modular components 24. FIG. 13 serves by way of example and not limitation; other tackle box styles and shapes may be envisioned, using the teachings disclosed herein, for receipt of the modular components 24.

Accordingly, as shown in FIG. 12 and FIG. 13 the present invention provides a modular storage system 20 whereby the angler or other user may individually select and interconnect various modular components 24 containing those lures, gear, or other items needed for a particular fishing trip. The angler may then transport a plurality of modular components 24 as is shown in FIG. 10. Alternatively, the angler may decide to transport these components in a tackle box configured perhaps as tackle box 66 or upon a belt 58 using attachment 56. Other variations may be apparent using the teachings disclosed herein, and all are within the spirit and scope of the present invention.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part. Therefore, the spirit and scope of the appended claims should not be limited to the description of the preferred versions contained therein.

What is claimed is:

1. A modular component of an expandable storage system, comprising:
a receptacle having a plurality of sides and a bottom, said receptacle having an interior and an opening for accessing the interior of said receptacle;
a door attached to said receptacle and configured for selectively covering and uncovering the opening; and
means for selectively attaching said receptacle to the exterior of other receptacles having complementary attachment means, said means being exteriorly located on at least two of said plurality of sides.

2. A modular component of an expandable storage system as in claim 1, wherein said means comprises:
at least one male connector located on one of the plurality of sides,
at least one female connector located on another of the plurality of sides, said female connector being configured for the receipt of a male connector of an adjacent receptacle so as allow for the formation of the expandable storage system.

3. A modular component of an expandable storage system as in claim 2, further comprising at least one of a male or female connector located on the bottom of said receptacle and configured for the complementary receipt of a male or female connector located on another receptacle so as to allow for the formation of the expandable storage system.

4. A modular component of an expandable storage system as in claim 2, wherein said male or said female connector is integrally formed with at least one of the sides of said receptacle.

5. A modular component of an expandable storage system as in claim 1, wherein said receptacle further comprises compartments within the interior of said receptacle.

6. A component of an expandable storage system, comprising:
a compartment having four walls and a bottom, an interior and an exterior, with said four walls configured so as to form an access to the interior of said box;
a door for opening and closing the access of said compartment,
a hinge integrally formed from said door and said compartment and configured for allowing said door to open and close the access of said compartment;
a first connector, exteriorly located upon a first of the four walls;
a second connector, exteriorly located upon a second of the four walls, wherein the second wall is parallel to the first wall of said compartment; and
a third connector, exteriorly located upon the bottom of said compartment;
whereby said connectors are configured to allow said compartment to be releasably connected to the exterior of other compartments configured with complementary connectors.

7. A component of an expandable storage system as in claim 6, wherein said first connector and said second connector are integrally formed from the walls of said compartment.

8. A component of an expandable storage system as in claim 7, wherein said third connector is integrally formed from the bottom of said compartment.

9. A component of an expandable storage system as in claim 6, wherein
said first connector is a male fastener configured for being matingly connected with female fasteners located in complementary fashion upon the exterior of other compartments; and
said second connector is a female fastener configured for being matingly connected with male fasteners located in complementary fashion upon the exterior of other compartments.

10. A component of an expandable storage system as in claim 6, wherein said third connector is comprised of:
a male fastener configured for being matingly connected with female fasteners located in complementary fashion on other compartments; and
a female fastener configured for being matingly connected with male fasteners located in complementary fashion on other compartments.

11. A component of an expandable storage system as in claim 6, wherein said compartment is constructed from plastic.

12. An expandable storage system, comprising:
a container having at least two generally parallel sides, a bottom, and an opening to the interior of said container;
a top cover configured for selectively covering the opening to said container; and
a plurality of connectors located upon the two generally parallel sides of said container, said plurality of connectors configured such that said container may be connected to other adjacently disposed containers also having complementary connectors located along the respective sides thereof so as to form the expandable storage system.

13. An expandable storage system as in claim 12, further comprising:
a locking pin located on said container; and
a receiving latch located on said top cover and configured for the receipt of said locking pin, whereby said top cover may by selectively locked into place when covering the opening to said container.

14. An interconnected storage system, comprising:
a plurality of interconnected storage containers wherein each storage container is defined by planar sides and a bottom;
a lid for each said storage container, configured for selectively opening or closing each said storage container;
a first connector located on at least one of the planar sides of each said containers; and
a second connector located on at least one other planar side of each of said containers, said second connector configured for the receipt of a first connector of an adjacent said container, whereby each said storage container may be connected to another said storage container to form said plurality of interconnected storage containers.

15. An interconnected storage system as in claim 14, wherein each said storage container further comprises at least two internal compartments.

16. An interconnected storage system as in claim 14, further comprising a latch located on each of said storage containers, whereby said lid for each of said storage containers may be selectively secured.

17. An interconnected storage system as in claim 14, further comprising:
a third connector located on the bottom of each of said storage containers, and
a fourth connector located on the bottom of each of said storage containers, said fourth connector configured for the receipt of a third connector of another said storage container, whereby said containers may be connected to form said plurality of interconnected storage containers.

18. An interconnected storage system as in claim 17, wherein said first connector, said second connector, said third connector, and said fourth connector of each of said storage containers are integrally formed from the sides of said storage containers.

19. A modular storage system, comprising:
compartments, each having an interior and an exterior, a first side and a second side;
lids attached to said compartments and configured for selectively opening or closing said compartments; and
a plurality of connectors located in complementary fashion on the first sides and the second sides such that said compartments may be removably connected to each other in adjacent disposition to form the modular storage system.

20. A modular storage system as in claim 19, wherein said compartments are divided into subcompartments.

21. A modular storage system as in claim 19, wherein said plurality of connectors comprises:
at least one male connector located on the first side of each of said compartments; and
at least one female connector located on the second side of each of said compartments, said female connector being configured for the receipt of a male connector located in complementary fashion on an adjacently disposed compartment so as to allow said compartments to be connected to form the modular storage system.

22. A modular storage system as in claim 19, further comprising a clasp for selectively securing said lid to said compartment.

23. A multicomponent storage system, comprising:
a plurality of containers, wherein each of said containers has an interior and an exterior;
fasteners positioned on the exterior of each of said containers, said fasteners configured for selectively attaching said containers together in adjacent fashion to form said plurality of containers; and
covers connected to each of said containers and configured for selectively accessing the interior of each of said containers.

24. A multicomponent storage system as in claim 23, wherein each of said containers further comprises:
a first wall having at least one of said fasteners located thereon; and
a second wall having at least one of said fasteners located thereon, said second wall being generally parallel to said first wall; and

25. A multicomponent storage system as in claim 23, wherein said fasteners are integrally formed from said containers.

26. A multicomponent storage system as in claim 23, wherein each of said containers further comprises interiorly located compartments.

27. A multicomponent storage system as in claim 23, wherein each of said containers further comprises a bottom having at least one of said fasteners located thereon and configured for selectively attaching said fastener to complementary fasteners located in complementary fashion on other containers or surfaces.

28. A multicomponent storage system as in claim 27, further comprising:
a carrier configured for attachment to a belt; and
fasteners located along said carrier and configured for selectively attaching the bottom of each of said containers to said carrier.

29. A multicomponent storage system as in claim 27, further comprising:
a tackle box configured for the complementary receipt of said fasteners whereby said plurality of containers may be attached to said tackle box.

30. A modular tackle box system, comprising:
a plurality of interconnected storage containers, wherein each said storage container is defined by at least two generally parallel sides and a bottom;
a lid for each of said storage containers, wherein each lid is attached to one of said storage containers and is configured for opening or closing such storage container;
a first connector configured on at least one of the generally parallel sides of each of said storage containers;
a second connector configured on another of the generally parallel sides of each of said storage containers; wherein said second connector is configured for complementary receipt of the first connector of an adjacently positioned storage container; and
a third connector configured on the bottom of each of said storage containers.

31. A modular tackle box system as in claim 30, wherein said interconnected storage containers are constructed from plastic.

32. A modular tackle box system as in claim 30, further comprising:
a tackle box carrier configured for attachment to a belt;
fasteners positioned upon said carrier, each of said fastener being configured for complementary receipt of said third connector, whereby said plurality of interconnected storage containers may be attached to said carrier.

33. A modular tackle box system as in claim 30, further comprising a fishing lure located within at least one of said plurality of interconnected storage containers.
